(19) United States
(12) Patent Application Publication
(10) Pub. No.: US 2011/0128386 A1
(43) Pub. Date: Jun. 2, 2011

(54) INTERACTIVE DEVICE AND METHOD FOR USE

(75) Inventors: Julien Letessier, Grenoble (FR); Jerome Maisonnasse, Champ-pres-Froges (FR); Nicolas Gourier, Grenoble (FR); Stanislaw Borkowski, La Tronche (FR)

(73) Assignee: HILABS, MEYLAN (FR)

(21) Appl. No.: 13/056,067

(22) PCT Filed: Jul. 29, 2009
(86) PCT No.: PCT/FR2009/000952

§ 371 Date: Jan. 26, 2011

(30) Foreign Application Priority Data
Aug. 1, 2008 (FR) 08 04387

(51) Int. Cl. H04N 5/33

(52) U.S. Cl. 348/164; 348/E05.09

(57) ABSTRACT

The interactive device comprises image capture means, at least one interaction space and means for producing an infrared light beam, comprising at least one light source emitting in the near-infrared range, directed towards the interaction space. The capture means comprise at least two infrared cameras covering said interaction space, and a peripheral camera covering the interaction space contained in an external environment. The device further comprises a transparent panel delineating on the one hand the interaction space included in the external environment and on the other hand an internal space in which the light source and capture means are arranged. It comprises at least one support element supporting said light source and/or the infrared cameras and at least one partially reflecting complementary element, the support element and complementary element being separated by the transparent panel.

### BACKGROUND OF THE INVENTION

The invention relates to an interactive device comprising image capture means, at least one interaction space and means for producing an infrared light beam directed towards the interaction space and comprising at least one light source emitting in the near-infrared range, said capture means comprising at least two infrared cameras covering said interaction space, said capture means being connected to a processing circuit, said device comprising a transparent panel delineating on the one hand the interaction space included in an external environment and on the other hand an internal space in which the light source and capture means are arranged, said capture means comprising a peripheral camera for capturing images representative of the external environment in the visible range.

### STATE OF THE ART

The document US-A-2006/0036944 describes an interactive device, illustrated in FIG. 1, comprising at least two infrared cameras IR1 and IR2 directed towards a rear surface of an interactive transparent film 1 acting as a screen onto which images are projected by means of a video projector 2. A user can interact with interactive film 1 by touching the latter or by making movements at a small distance from this film. Although the device described can determine the position of a hand or of fingers, if several fingers or hands are in contact with film 1, the device is not able to determine whether the fingers belong to the same hand or whether two hands are in contact with the surface. Nor is the device able to distinguish the context, i.e. to determine whether these two hands belong to the same user or to several users and to adapt the interaction to the distance of the user.

The document US-A-2003/0085871 describes a pointing device for an interactive surface. The device comprises a screen equipped with a camera at each of its opposite top edges. The cameras cover a display surface of the screen forming the interactive surface and are connected to a processor able to extrapolate the positioning of a hand or a pen on the plane formed by the interactive surface from images captured by the cameras. The whole of the interactive surface is illuminated by infrared diodes situated close to the cameras. To optimize operation of the device in daylight, the area corresponding to the display surface is surrounded by a strip reflecting infrared rays. Although the device can perceive movements of a hand at the level of the interactive surface, in the case where fingers of hands corresponding to several users are in contact with this surface, the processor is not able to determine whether the fingers belong to several users or to one and the same person. The device is therefore not suitable for large interactive surfaces designed to be used by a plurality of persons.

The document WO2006136696 describes an elongate bar comprising light-emitting diodes and cameras directed so as to cover an interaction space. When such a bar is used in a show-window, it has to be arranged outside the show-window, which means that a hole has to be made in the show-window to connect the bar to computer processing or other means (power supply, etc.). Furthermore, the bar being situated at the outside means that the latter can easily be vandalized.

None of the devices of the prior art enable the interaction to be adapted according to the distance of the persons and/or of the visual context in the vicinity of the surface.

### OBJECT OF THE INVENTION

The object of the invention is to provide a device that is easy to install and that is able to be used on the street or in a public area by one or more users and that is not liable to be vandalized or stolen.

This object is achieved by the appended claims and in particular by the fact that the device comprises at least one support element supporting said light source and/or the infrared cameras and at least one partially reflecting complementary element, the support element and complementary element being separated by the transparent panel.

The invention also relates to a method for using the device comprising a repetitive cycle successively comprising:
an acquisition step of infrared images by the infrared cameras and of images in the visible range by the peripheral camera,
processing of the acquired images,
merging of the infrared and visible images to generate an image representative of the external environment,
tracking of the users situated in the external environment.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1 illustrates an interactive device according to the prior art.

FIG. 2 illustrates an interactive device according to a first particular embodiment of the invention.

FIGS. 3 and 4 illustrate an interactive device according to a second particular embodiment of the invention, respectively in front view and in top view.

FIG. 5 illustrates a support bar used in the device according to FIGS. 3 and 4 in greater detail, in front view.

FIG. 6 represents a cross-sectional view along the line A-A of the device of FIG. 4.

FIG. 7 schematically represents an algorithm of use of the device according to the invention.

FIGS. 8 and 9 represent the processing step E4 of the images of the algorithm of FIG. 7 in greater detail.

FIG. 10 illustrates the foreground/background segmentation step E19 of FIG. 9 in greater detail.

FIG. 11 illustrates a foreground/background segmentation learning algorithm.

FIG. 12 illustrates the actimetry step E5 of the algorithm of FIG. 7 in greater detail.

FIG. 13 illustrates the proximity step E7 of the algorithm of FIG. 7 in greater detail.

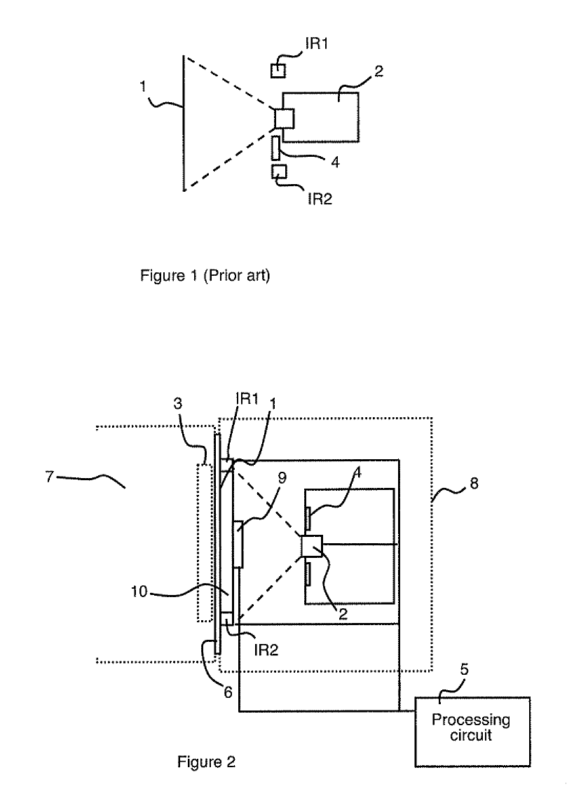

### DESCRIPTION OF PREFERRED EMBODIMENTS

According to a first embodiment illustrated in FIG. 2, the interactive device comprises display means formed for example by a transparent or semi-transparent diffusing film 1 acting as display screen, and a video projector 2 directed towards transparent film 1 and performing overhead projection onto the film. The interactive device comprises at least one interaction space 3 illuminated by means for producing an infrared light beam directed towards this interaction space 3. What is meant by interaction space is a volume with which a user can interact. The means for producing the light beam comprise at least one light source 4 emitting in the near-infrared range, for example with wavelengths comprised between 800 nm and 1000 nm. The interactive device also comprises image capture means constituted by at least two infrared cameras IR1 and IR2. Each of the infrared cameras is directed towards interaction space 3 so as to cover the whole of the volume corresponding to this space and to detect objects located in this space. Infrared cameras IR1 and IR2 are connected to a data processing circuit 5 itself connected to the video projector to modify the display, for example when infrared cameras IR1 and IR2 detect a movement of an object in interaction space 3.

As illustrated in FIG. 2, the interactive device further comprises a transparent panel 6 delineating interaction space 3 included in an external environment 7 on the one hand and an internal space 8 on the other hand. The display means (transparent film 1 and video projector 2), infrared light source 4, and the capture means formed by infrared cameras IR1 and IR2, and a peripheral camera 9 are all arranged in an internal space 8. Peripheral camera 9 is designed for capture of images in the visible range and directed in such a way as to cover a volume representative of environment external 7 (broken line in FIG. 2), this peripheral camera 9 is also connected to the display means. The device further comprises a support element 10 supporting the light source and/or infrared cameras IR1, IR2. This support element 10 is designed to be fixed near to transparent panel 6 in internal space 8. Support element 10 is preferably pressing on transparent panel 6. This configuration is rendered optimal by the use of at least one partially reflecting complementary element 11 (not shown in FIG. 2), complementary element 11 and support element 10 then being separated by transparent panel 6. The reflecting part of the complementary element enables light source 4 and/or infrared cameras IR1, IR2 to be directed so as to cover interaction space 3.

Transparent film 1, arranged in internal space 8, is preferably located in immediate proximity to transparent panel 6 or even stuck directly on the latter.

Interaction space 3 defines a volume in which the user can interact with the display performed by the display means. It is thereby possible to modify the display by means of one's hands, fingers or any held object (a rolled-up newspaper for example) in the same way as it is possible to do so on a conventional computer screen by means of a mouse. Interaction space 3 thereby acts as user interface, the different movements of the user in this space being detected by infrared cameras IR1 and IR2 and then interpreted by processing circuit 5 to retranscribe a user feedback on the display means according to the movement made. Thus, when a user stands in front of interaction space 3 at a personal interaction distance determined by adjustment of the infrared cameras according to the depth of the infrared space, the position of his/her hands, fingers or of the object he/she is holding is estimated by detection, enabling him/her to interact with interaction space 3 by studying the movements and/or behavior of his/her hands or fingers.

Video projector 2 of the device of FIG. 2 is preferably equipped with a band-stop filter in the infrared range limiting disturbances of the images captured by the infrared cameras.

It is preferable for transparent film 1 and transparent panel 6 to be totally transparent to the infrared radiation wavelength used by light source 4 and by cameras IR1 and IR2.

Peripheral camera 9 is preferably placed at a distance from transparent panel 3 so as to cover a fairly extensive external environment.

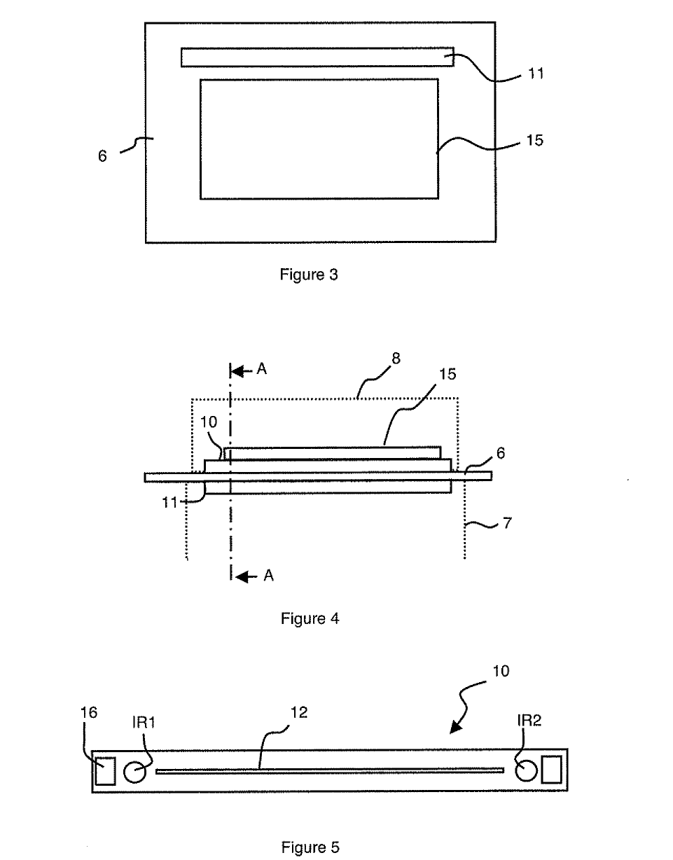

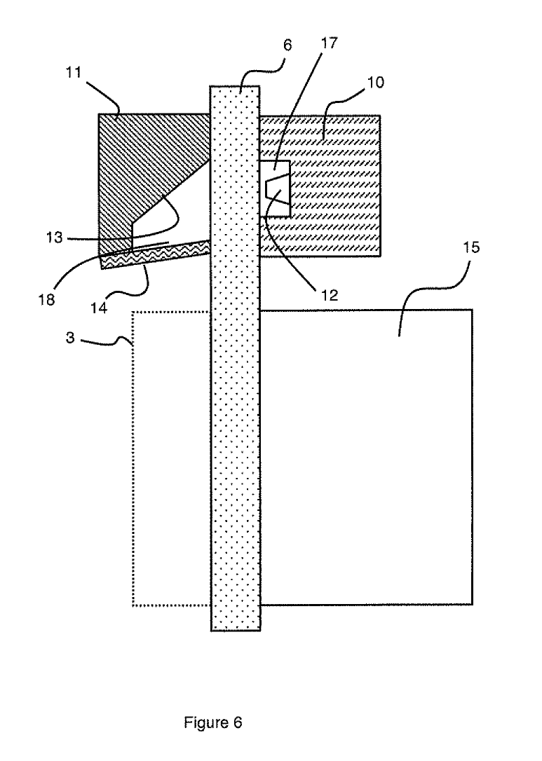

In a second mode embodiment illustrated in FIGS. 3 to 6, the display means comprise an opaque screen 15 placed in internal space 8. Such a screen is for example a cathode ray tube display, an LCD, a plasma screen, etc. The opaque screen may imply constraints on the location of infrared cameras IR1 and IR2 and of light source 4 emitting in the near-infrared in internal space 8. It is therefore advantageous for light source 4 and/or infrared cameras IR1 and IR2 to be supported by at least one support element 10 situated in internal space 8, for example above opaque screen 15. At least one at least partially reflecting complementary element 11 is situated in external environment 7. Complementary element 11 is designed to reflect the infrared light beams coming from the light source in interaction space 3 and to direct the field of vision of infrared cameras IR1 and IR2 so as to ensure total coverage of interaction space 3.

As illustrated in FIGS. 4 and 6, support element 10 can be formed by a support bar designed to be pressing against the surface of transparent panel 6 that is directed towards internal space 8. The light source can be in the form of a lighted strip 12 formed for example by a plurality of light-emitting diodes (LEDs). Strip 12 is arranged along the surface of the support bar which is pressing against transparent panel 6. Strip 12 is preferably placed at the bottom of an open longitudinal cavity 17 formed in the support bar. Strip 12 is thus not arranged salient with respect to the support bar, which would prevent support bar from being pressed against transparent panel 6. Infrared cameras IR1 and IR2 are preferably housed in the support bar, at each end of lighted strip 12.

As illustrated in FIG. 6, complementary element 11 can be in the form of a complementary bar comprising an inclined surface 13 directed both towards transparent panel 6 (in the direction of lighted strip 12 and/or infrared cameras IR1 and IR2), and also towards interaction space 3 when the complementary bar is fitted on the external surface of panel 6 directed towards external environment 7. For example purposes in FIG. 6, panel 6 being vertical, elements 10 and 11 located on the top part of the panel and internal space 8 situated on the right of panel 6, surface 13 is inclined downwards and makes an angle of about 45° with the panel. Inclined surface 13 comprises reflecting means, for example a reflecting surface acting as a mirror, to propagate the infrared light to interaction space 3 and/or to direct the field of vision of infrared cameras IR1, IR2 in this same direction so as to cover the whole of interaction space 3.

The support bar and complementary bar can be kept facing one another on each side of transparent panel 6 by means of complementary magnets (not shown) situated for example at each end of each bar, sandwiching transparent panel 6 or more simply by adhesion.

The complementary bar preferably comprises a protection plate 14 transparent to the infrared radiation considered, fixed onto a bottom surface of the complementary bar. Thus, when as illustrated in FIG. 6 support bar 10 and complementary bar 11 are pressing on each side of transparent panel 6, and protection plate 14 forms a recess 18 delineated by inclined surface 13 and a portion of panel 6. In this way no element can come and lodge itself in this recess and disturb correct operation of the interactive device. In addition, without protection plate 14, inclined surface 13 would have to be cleaned regularly and cleaning would be difficult on account of the positioning of inclined surface 13 in the recess, whereas protection plate 14 can be cleaned easily by simply using a rag. Protection plate 14 is preferably inclined 15° with respect to the horizontal, this incline enabling nuisance reflections in the field of vision of infrared cameras IR1 and IR2 to be eliminated.

The use of the complementary bar avoids having to make a hole in transparent panel 6 to run wires connected for example to processing circuit 5, the electronic elements being situated in internal space 8.

Transparent panel 6 can for example be formed by a window pane of commercial premises, a glass table-top, or a sheet of glass placed on the ground behind which a technical enclosure is located delineating the internal space of the device.

The embodiments described above present the advantage of protecting the elements sensitive to theft and damage, such as the cameras, screen, video projector, etc. By transferring their location to the internal space, they are in fact no longer accessible from a public area.

In general manner, the precise arrangement of infrared cameras IR1 and IR2 and of peripheral camera 9 in internal space 8 has little importance so long as the infrared cameras are directed in such a way as to cover interaction space 3 and peripheral camera covers external environment 7. Direction of infrared cameras IR1, IR2 and/or light source 4 is performed by reflecting means able to be based on mirrors forming the reflecting part of complementary element 11.

Peripheral camera 9 detecting the light radiations having a wavelength in the visible range makes it possible to have a wider vision and to analyze external environment 7. Peripheral camera 9 mainly completes and enriches the data from the infrared cameras. Processing circuit 5 can thus reconstitute a three-dimensional scene corresponding to external environment 7. The three-dimensional scene reconstituted by processing circuit 5 makes it possible to distinguish whether several users are interacting with interaction space 3 and to dissociate the different movements of several users. These movements are determined in precise manner by studying a succession of infrared images. Dissociation of the movements according to the users makes it possible for example to associate an area of the interaction space with a given user, this area then corresponding to an area of the display means, the device then becoming multi-user.

According to a development, peripheral camera 9 enables external environment 7 to be divided into several sub-volumes to classify the persons detected by the peripheral camera in different categories according to their position in external environment 7. It is in particular possible to distinguish the following categories of persons: passer-by and user. A passer-by is a person passing in front of the device, at a certain distance from the latter and not appearing to show an interest, or a person near the interactive device, i.e. able to visually distinguish elements displayed by the display means or elements placed behind panel 6. A user is a person who has manifested a desire to interact with the interactive device by his/her behavior, for example by placing his/her fingers in interaction space 3.

For example purposes, the volume can be divided into 4 sub-volumes placed at a more or less large distance from transparent panel 6, which can be constituted by a show-window. Thus a first volume farthest away from transparent panel 6 corresponds to an area for distant passers-by. If there is no person present in the volumes nearer to panel 6, images of the surroundings are displayed. These images do not especially attract the attention of passers-by passing in front of the panel, as the latter are too far away. A second volume, closer to the window is associated with close passers-by. When the presence of a close passer-by is detected in this second volume, processing circuit 5 can change the display to attract the eye of the passer-by or for example to diffuse a message via a loudspeaker to attract the attention of the passer-by. The presence of a person in a third volume, even closer to transparent panel 6 than the second volume, leads processing circuit 5 to consider that the person's attention has been captured and that he/she can potentially interact with interaction space 3. Processing circuit 5 can then modify the display to bring the person to come even closer and become a user. A fourth volume corresponds to the previously defined interaction space 3. The person then becomes a user, i.e. a person having shown a desire to interact with the screen by his/her behavior and whose hands, fingers or a held object are located in interaction space 3.

By means of peripheral camera 9, all the elements of the device can propose users a riche interaction suited to their context, and the device can become multi-user while at the same time adapting the services provided to the involvement of the person in the interaction.

According to a development, the interactive device does not comprise display means. It can thus be used in a show-window comprising for example objects, and the resulting interaction space 3 corresponds substantially to a volume arranged facing all the objects. The data is acquired in similar manner to the device comprising display means and can be analyzed by the processing circuit to provide the owner of the show-window with information according to the interest shown by the persons in the different products present in the show-window. The show-window can naturally also comprise a miniature screen to enable information to be displayed on an object in the shop-window when a user points at the object concerned with his/her finger. This development can be used with the devices, with or without display means, described in the foregoing.

The invention is not limited to the particular embodiments described above, but more generally extends to cover any interactive device comprising display means or not, image capture means, at least one interaction space 3 and means for producing an infrared light beam directed towards interaction space 3 and comprising at least one light source 4 emitting in the near-infrared. The capture means comprise at least two infrared cameras IR1 and IR2 covering interaction space 3 and are connected to a processing circuit 5 connected to the display means (if present). Transparent panel 6 delineates on the one hand interaction space 3 included in external environment 7, and on the other hand internal space 8 in which light source 4, capture means and display means, if any, are arranged. The capture means further comprise a peripheral camera 9 for capturing images in the visible range representative of external environment 7.

The embodiment with two elements and its variants can be used whatever the type of display means (screen or transparent film) and even in the case where there are no display means.

Use of the device comprises at least the following steps:
an acquisition step of infrared images E1, E2 by infrared cameras IR1 and IR2 and of images in the visible range E3 by peripheral camera 9,
processing of the acquired images,
merging of the infrared and visible-range images to generate an image representative of external environment 7 including interaction space 3,
tracking of persons situated in the external environment,
and in the case where the device comprises display means, modification of the display according to the movements of persons, considered as users, at the level of interaction space 3 or of the external environment.

As the device operates in real time, these steps are repeated cyclically and are processed by the processing circuit.

The processing performed by processing circuit 5 on the images coming from the different cameras enables the reactions of the device to be controlled at the level of the display by information feedback to the users.

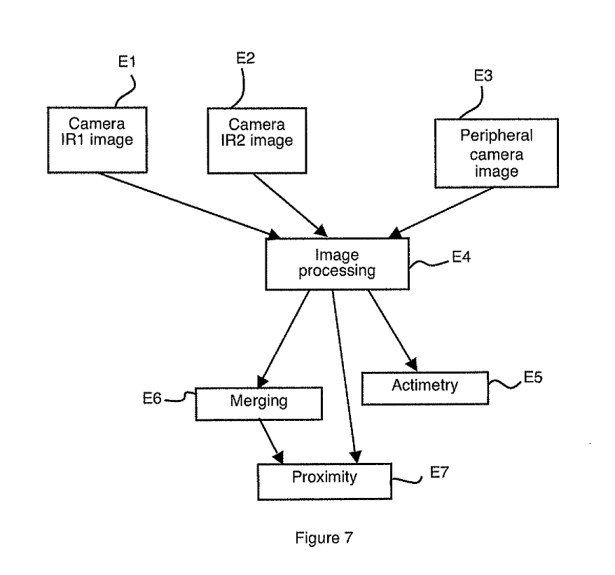

Processing circuit 5 thus analyzes the images provided by cameras IR1, IR2 and 9 and controls the display according to the context of the external environment. The general algorithm illustrated in FIG. 7, at a given time t, comprises acquisition steps E1 and E2 of infrared images coming from infrared cameras IR1 and IR2 and an acquisition step E3 of an image in the visible range from peripheral camera 9. The different images thus acquired are then processed in an image processing step E4 to rectify the images and then determine the position of the hands, fingers, persons, etc. close to interaction space 3. From the results of the image processing step, an actimetry step E5 determines the different properties of each person present in the field of vision of peripheral camera 9. For example purposes, the properties of a person are his/her sex, age and possibly socio-professional category, determined for example according to his/her global appearance. Again from the results of image processing step E4, a merging step E6 of the infrared images and of the images from the peripheral camera, associates the hands, fingers and/or object belonging to a specific user, by combining the images from infrared cameras IR1 and IR2 and from peripheral camera 9, and tracks the progression of persons in proximity to the screen according to their previous position (at a time t−1 for example). Databases in which the previous data is stored are updated with the new data thus obtained. After the hands and fingers have been attributed to the corresponding user, processing circuit 5 is able to perform tracking of the user's movements according to the previous positions of his/her hands and/or fingers and to update the display accordingly. In parallel and/or following merging step E6, a proximity step E7 uses tracking of the persons and detection of the fingers, hands or objects to calculate a proximity index of the person with interaction space 3 and to detect whether a person moves closer, moves away or disappears, representative of his/her interest for the display. The proximity index is representative of his/her position with respect to interaction space 3 and is used for example to attempt to attract the attention of persons according to their interest for the displayed contents or to detect the absence of persons in front of the display screen, thereby avoiding false detections of users if no finger/hand/object is present in interaction space 3.

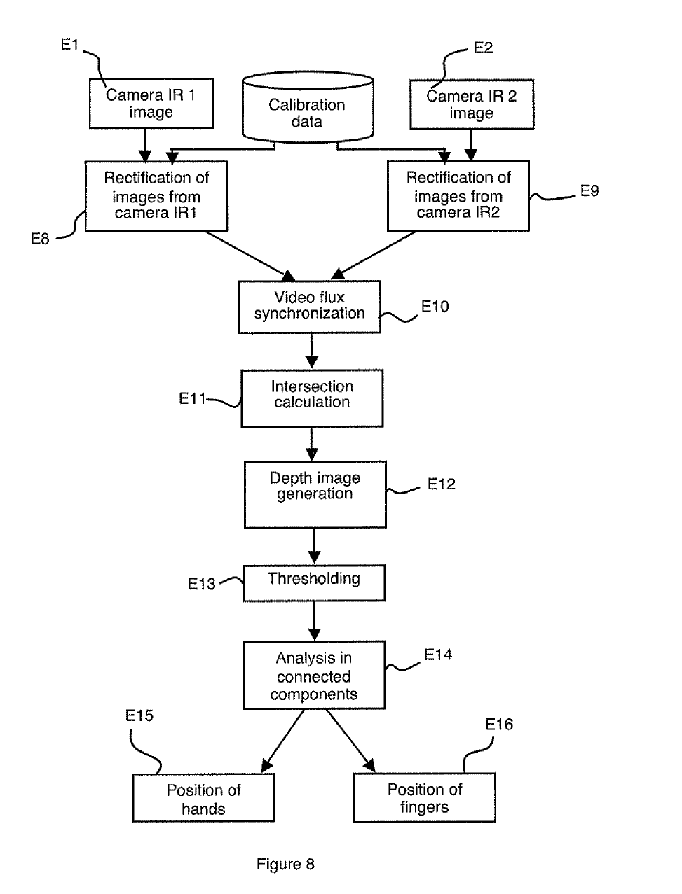

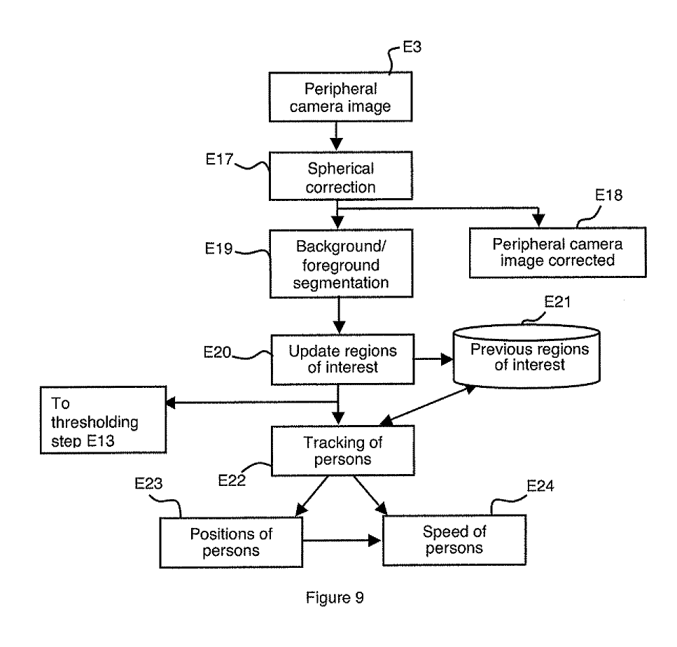

In image processing step E4, the infrared images from each infrared camera IR1 and IR2 are each rectified separately (steps E8 and E9), as illustrated by the diagram of FIG. 8, to take account of the viewing angle of cameras IR1 and IR2. Rectification of the images provided by cameras IR1 and IR2 can thereby be performed by applying a 4×4 projection matrix to each pixel. The result obtained corresponds, for each rectified image, to a detection area parallel to panel 6, corresponding to interaction space 3 and able to be of substantially equal size to the display surface which can be arranged facing interaction space 3.

The projection matrix is preferably obtained by calibrating the device. A first calibration step consists in determining detection areas close to the screen, in particular to define interaction space 3. Calibration is performed by placing an infrared emitter of small size against transparent panel 6, facing each of the four edges of the display surface of the display means, and by activating the latter so that it is detected by infrared cameras IR1 and IR2. The position in two dimensions (x,y) of the corresponding signals in the two corresponding images is determined by binarizing the images acquired by infrared cameras IR1 and IR2 when the infrared emitter is activated with a known thresholding method (of local or global type), and by analyzing these images in connected components. Once the four positions (x,y) corresponding to the four corners have been obtained, a volume forming the detection area (interaction space) in the infrared range is determined by calculation for each infrared camera. For each camera, the device will ignore data acquired outside the corresponding volume. The four corners are then used to calculate the 4×4 projection matrix enabling the images acquired by the infrared cameras to be rectified according to their position.

A second calibration step consists in pointing a succession of circles displayed on the display surface (film 1 or screen 15) placed behind transparent panel 6 in interaction space 3 with one's finger. Certain circles are displayed in areas close to the corners of the display surface and are used to calculate a homography matrix. The other circles are used to calculate parameters of a quadratic correction able to be modeled by a second degree polynomial on x and y.

After calibration, the parameters of the two projection matrices (one for each infrared camera) of the homography matrix and of the quadratic correction polynomial are stored in a calibration database 19 (FIG. 8) and are used to rectify the infrared images from cameras IR1 and IR2 in steps E8 and E9.

The advantage of this calibration method is to enable the device to be calibrated simply without knowing the location of the cameras when installation of the device is performed, for example in a shop window, so long as interaction space 3 is covered both by cameras IR1 and IR2 and by light source 4. This calibration further enables less time to be spent in plant when manufacturing the device, as calibration no longer has to be performed. This method further enables the device installed on site to be easily recalibrated.

After rectification of the infrared images, the different images are synchronized in a video flux synchronization step E10. The images coming from the different infrared cameras are then assembled in a single image called composite image and the rest of the processing is carried out on this composite image.

The composite image is then used to calculate the intersection of the field of vision of the different cameras with a plurality of planes parallel to panel 6 (step E11) to form several interaction layers. For each parallel plane, a reference background image is stored in memory when the differences between the current image and the previous image of this plane are lower than a threshold during a given time. Interaction with the different parallel planes is achieved by calculating the difference with the corresponding reference images.

A depth image is then generated (step E12) by three-dimensional reconstruction by grouping the intersections with the obtained planes and applying stereoscopic mapping. This depth image generation step (E12) preferably uses the image provided by peripheral camera 9 and analyzes the regions of interest of this image according to the previous images to eliminate wrong detections in the depth image.

The depth image is then subjected to a thresholding step E13 in which each plane of the depth image is binarized by thresholding of global or local type, depending on the light conditions for each pixel of the image or by detection of movements with a form filter. Analysis of the light conditions coming from the image acquired by peripheral camera 9 during processing thereof enables the thresholding to be adjusted and the light variations during the day to be taken into account, subsequently enabling optimal detection of the regions of interest.

Finally, after thresholding step E13, the planes of the binarized depth image are analyzed in connected components (step E14). In known manner, analysis in binary 4-connected components enables regions to be created by grouping pixels having similar properties and enables a set of regions of larger size than a fixed threshold to be obtained. More particularly, all the regions of larger size than the fixed threshold are considered as being representative of the objects (hands, fingers) the presence of which in interaction space 3 may cause modifications of the display, and all the regions smaller than this threshold are considered as being non-relevant areas corresponding for example to noise in the images. The regions obtained are indexed by their center of gravity and their size in the images.

The result of step E14 enables it to determined whether a hand or a finger is involved by comparing the regions obtained with suitable thresholds. Thus, if the size of the region is larger than the fixed threshold, the region will be labeled as being a hand (step E15), and if the size of the region is smaller than the fixed threshold, the region is labeled as being a finger (step E16). The thresholds correspond for example for a hand to the mean size of a hand and for a finger to the mean size of a finger.

The coordinates corresponding to each region representative of a hand or a finger are calculated for each infrared camera. To calculate the relative position of the region and associate it with a precise area of the display surface, homographic transformation with its quadratic correction is applied from the coordinates of the regions in the previous images (state of the device at time t−1 for example). Steps E15 and E16 generate events comprising its position and its size for each region of interest, and these events are then analyzed by processing circuit 5 which compares the current position with the previous position and determines whether updating of the display has to be performed, i.e. whether a user action has been detected.

Homographic transformation coupled with quadratic correction enables infrared cameras IR1 and IR2 to be placed without adjusting their viewing angle, simple calibration of the device being sufficient. This makes installation of the device particularly easy.

By means of processing of the infrared images, the device is able to distinguish pointers (hands, fingers or objects) interacting in the interaction space 3 with precise areas of the display surface.

However, processing circuit 5 is not yet capable of determining which different users these pointers belong to. That is why, for each infrared image capture, a corresponding image in the visible range is captured by peripheral camera 9 and then processed in parallel with processing of the infrared images (step E4). As illustrated in FIG. 9, processing of the image from peripheral camera 9 first of all comprises a spherical correction step E17, in particular when the peripheral camera comprises a wide-angle lens. The choice of equipping the peripheral camera with a wide-angle lens is in fact judicious as the wide angle enables a larger external environment to be covered. However, this type of lens causes a perspective effect tending to make different planes of the same image appear farther away from one another than they really are, unlike telescopic lenses which rather tend to squeeze the subjects closer to one another in one and the same plane. This spherical deformation is preferably rectified by modeling this deformation in known manner by a second degree polynomial, which takes the distance between the current point and the center of the image on input for each point of the image, and which sends back the corrected distance between the center of the image and this current point. The corrected image from peripheral camera 9 is then recorded in the memory of processing circuit 5 (step E18).

The corrected image obtained in step E17 is then also used to perform a background/foreground segmentation step E19. This step binarizes the corrected image in step E17 so as to discriminate between the background and the foreground. The foreground correspond to a part of external environment 7 in which the detected elements correspond to users or passers-by, whereas the background is a representation of the objects forming part of a background image (building, parked automobile, etc.). A third component called the non-permanent background corresponds to new elements in the field of vision of peripheral camera 9, but which are considered as being irrelevant (for example an automobile which passes through and then leaves the field of vision). Segmentation makes it possible to determine the regions of the image corresponding to persons, called regions of interest. These regions of interest are for example represented in the form of ellipses.

On completion of segmentation step E19, if a change of light conditions is detected, the global or local thresholding used in thresholding step E13 is preferably updated.

After segmentation step E19, processing of the image from the peripheral camera comprises an updating step of regions of interest E20. The coordinates (center, size, orientation) of the regions of interest corresponding to persons in the current image are stored in memory (database E21). By comparing the previous images (database E21) with the current image, it is thereby possible to perform tracking of persons (step E22).

Detection of new persons can be performed in step E22 by applying a zero-order Kalman filter on each region of interest. By comparison with the previous coordinates of the regions of interest, the filter calculates a prediction area of the new coordinates in the current image.

From the data provided by tracking and detection of persons, the position E23 and then speed E24 of each person in the proximity of interaction space 3 can be determined. The speed of the persons in the proximity of interaction space 3 is obtained by calculating the difference between the coordinates of the regions of interest at the current moment with respect to the previous moments. The position of the persons in the proximity of interaction space 3 is determined by the intersection of a prediction area, dependent for example on the previous positions, the speed of movement and the binarized image obtained in segmentation step E19. A unique identifier is associated with each region of interest enabling tracking of this precise region to be performed.

The combination of images and data extracted during step E4 enables merging step E6 and actimetry step E5 to be performed.

In background/foreground segmentation step E19, each pixel of the image is defined (E25) by its color components. An element corresponding to a cloud of points in a color space (RGB or YUV) to determine whether a pixel belongs to an element, the color components of this pixel are compared with those of a nearby element, i.e. the minimum distance of which with the pixel is smaller than a predefined threshold. The elements are then represented in the form of a cylinder and can be labeled in three ways, for example foreground, background and non-permanent background.

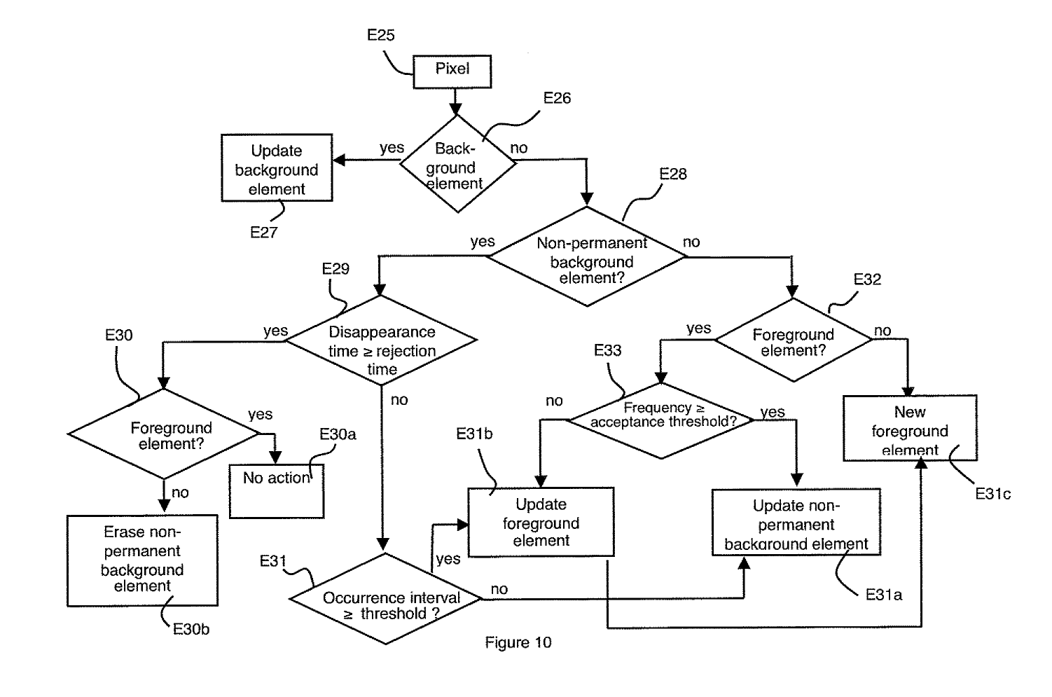

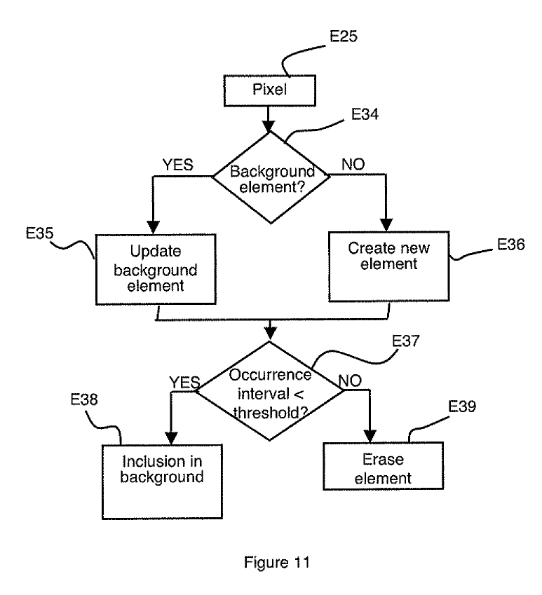

The algorithm of the background/foreground segmentation step is illustrated in FIG. 10. Thus, for each pixel of the corrected image from peripheral camera 9, a first test (step E26) will interrogate a database of the known background to determine whether or not this pixel is part of an element of the background.

If this pixel is part of an element of the background (yes output of step E26), then the database comprising the characteristics of the background is updated (step E27). If not (no output of step E26), the pixel is studied to check whether its color components are close to an element belonging to the non-permanent background (step E28). If the pixel is considered as being an element of the non-permanent background (yes output of step E28), then the disappearance time of this element is tested (step E29). If the disappearance time is greater than or equal to a predefined rejection time (yes output of step E29), a test is made to determine whether a foreground element is present in front of the non-permanent background element (step E30). If a foreground element is present (yes output of step E30), then no action is taken (step 30a). If not (no output of E30), in the case where no foreground element is present in the place of the non-permanent background element, the non-permanent background element is then erased from the non-permanent background (step E30b).

If on the other hand the disappearance time is not greater than the rejection time (no output of step E29), a test is made to determine whether the occurrence interval is greater than a predefined threshold (step E31). An occurrence interval represents the maximum time interval between two occurrences of an element versus time in a binary presence-absence succession. Thus, for a fixed element, an automobile passing will cause a disappearance of the object followed by a rapid re-appearance, and this element will preferably not be taken into account by the device. According to another example, an automobile parked for a certain time and then pulling away becomes a mobile object the occurrence interval of which becomes large. Movement of the leaves of a tree will generate a small occurrence interval, etc.

If the occurrence interval is shorter than a certain threshold (no output of step E31), then the pixel is considered as forming part of a non-permanent background element and the non-permanent background is updated (step 31a) taking account of the processed pixel. If not (yes output of step E31), the pixel is considered as forming part of a foreground element and the foreground is updated (step E31b) taking account of the processed pixel. If the foreground element does not yet exist, a new foreground element is created (step E31c).

In step E28, if the tested pixel does not form part of the non-permanent background (no output of step E28), a test is made to determine whether the pixel is part of an existing foreground element (step E32). If no foreground element exists (no output of step E32), a new foreground element is created (step E31c). In the case where the pixel corresponds to an existing foreground element (yes output of step E32), a test is made to determine whether the frequency of appearance of this element is greater than an acceptance threshold (step E33). If the frequency is greater than or equal to the acceptance time (yes output of step E33), the pixel is considered as forming part of a non-permanent background element and the non-permanent background is updated (step E31a). If not, the frequency being lower than the acceptance threshold (no output of step E33), the pixel is considered as forming part of an existing foreground element and the foreground is updated with the data of this pixel (step E31b).

This algorithm, executed for example at each image capture by processing circuit 5, makes it possible to distinguish the different elements in the course of time and to associate them with their corresponding plane. A non-permanent background element will thus first be considered as a foreground element before being considered as what it really is, i.e. a non-permanent background element, if its frequency of occurrence is high.

The background/foreground segmentation step is naturally not limited to the algorithm illustrated in FIG. 10 but can be achieved by any known type of background/foreground segmentation such as for example described in the document “Real-time foreground-background segmentation using codebook model” by Kim et al. published in “Real Time Imaging” volume 11, pages 172 to 185 in June 2005.

A foreground/background segmentation process qualified as learning process is activated cyclically. This process on the one hand enables the recognition performed by peripheral camera 9 to be initialized, but also keeps the vision of the external environment by processing circuit 5 consistent. Thus, as illustrated in FIG. 11, for each pixel appearing in the image captured by the peripheral camera, it is checked whether this pixel is part of a background element (step E34). If the pixel is part of a background element (yes output of step E34), the corresponding background element is updated (step E35). If the pixel is not part of the existing background element (no output of step E34), a new element is created (step E36). Then, according to step E35 or E36, the occurrence interval of the element associated with the pixel is tested (step E37). If this interval is lower than a certain threshold (yes output of step E37), the element is included in the background image (step E38). If on the other hand the interval is greater than the threshold (no output of step E37), the element is erased (step E39).

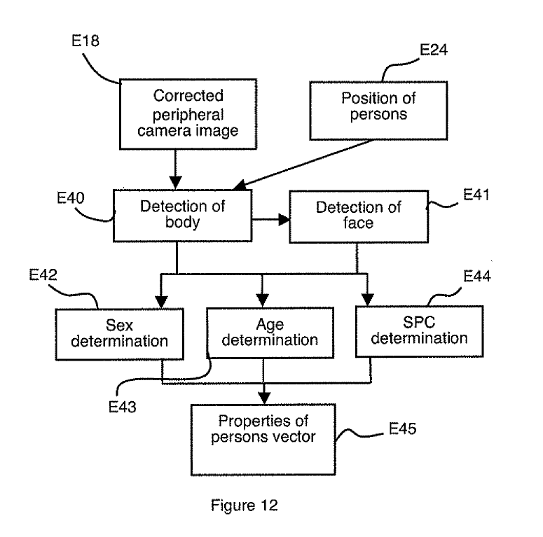

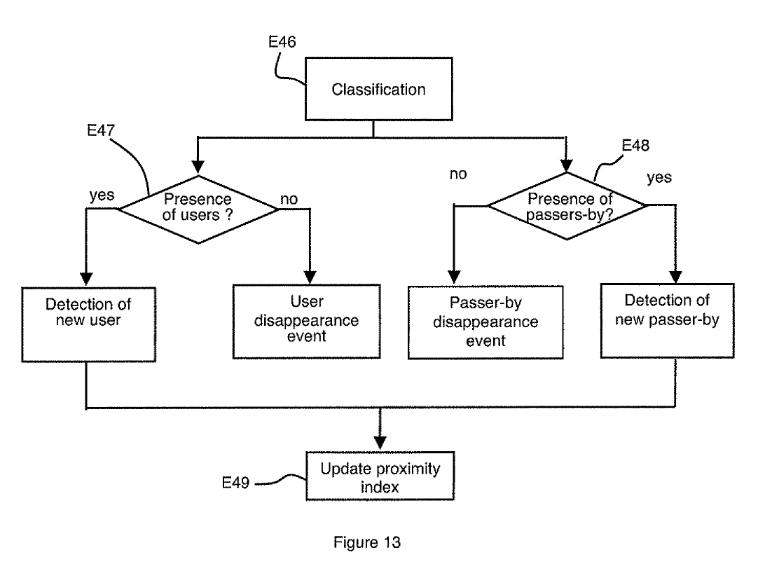

After processing step E4 has been performed (FIG. 7), the images from peripheral camera 9 can be used to determine the properties associated with a person. By analyzing the person's face and morphology, processing circuit 5 can thus at least approximately determine his/her sex, age and socio-professional category in order to display relevant data matching this person. This analysis corresponds to actimetry step E5 illustrated in greater detail in FIG. 12. Actimetry uses the image corrected in step E18 of FIG. 9 and the positions of the persons obtained in step E24 of FIG. 9 to perform calculation of the correspondences and to detect the body of the different persons (step E40), and then, for each body, the face associated with this body (step E41). From the study of the bodies and of their association with their respective faces, the actimetry process can for example determine the sex (step E42), age (step E43) and socio-professional category (SPC) of the persons (step E44) and create a vector representative of the properties of the persons (step E45) stored in the person tracking database. By knowing the property vector of a person, it is possible to display target content that is more likely to interest him/her.

Concordance of the relevant areas zones of the infrared image and the foreground can then be performed to determine who the fingers and hands interacting in interaction space 3 belong to and to associate them with a user, and then associate an area of interaction space 3 and an area of the display surface with each person. This is performed during merging step E6 of FIG. 7. From the position data of hands (E15) and fingers (E16), this step enables tracking of the hands and fingers to be established and associates these hands/fingers with a person identified by peripheral camera (E23). Several persons can thus interact in the same interaction space 3, and the movements of their hands/fingers can be processed by processing circuit 5. Tracking of the movements of the hands and/or fingers enables it to be determined what the user is doing in interaction space 3, for example towards what area he/she is pointing his/her finger at an object, and enables him/her to be provided with data associated with what he/she is looking at on the display. Association of hands, fingers or an object with a user can be performed by measuring coordinates of the hands/fingers/objects, with each new image, each hand/finger/object then being associated with the user whose coordinates are closest to the measured coordinates of the hands/fingers/objects present in interaction space 3.

The images acquired by peripheral camera 9 can be calibrated by placing a calibration sight in the field of vision of peripheral camera 9 in known manner. This calibration enables the precise position (distance, spatial coordinates, etc.) of the persons with respect to interaction space 3 to be known for each acquired image.

Proximity step E7 of FIG. 7 enables each person detected to be distinguished by classifying him/her in the user or passer-by category (step E46) according to his/her distance with respect to interaction space 3. If the distance between the person and interaction space 3 or panel 6 is smaller than a certain threshold, then the person is considered as a user, if not as a passer-by. The presence of users is then tested (step E47). If no user is present (no output of step E47), this then generates a user disappearance event which is processed by processing circuit 5. If a new user is detected (yes output of step E47), the coordinates of this user are stored. The presence of passers-by is tested at the same time (step E48). If no passer-by is present (no output of step E48), this then generates a passer-by disappearance event which is processed by processing circuit 5. If a new passer-by is detected (yes output of step E48), processing circuit 5 stores the coordinates of this passer-by.

Detection of a new user or of a new passer-by gives rise to updating (step E49) of a proximity index (coordinates and time of appearance) by processing circuit 5. Analysis of this index enables it to be determined whether a passer-by or a user is moving away or moving nearer according to his/her previous position.

The interactive device permanently monitors what is happening in the external environment and can react almost instantaneously when events (appearance, disappearance, movement of a person, movement of hands or fingers) are generated.

The dissociation between background and non-permanent background made by the segmentation step enables an automobile passing in the field of vision of the peripheral camera to be differentiated from movements repeated with a small time interval such as the leaves of a tree moving because of the wind.

1-14. (canceled)

15. An interactive device comprising image capture means, at least one interaction space and means for producing an infrared light beam directed towards the interaction space and comprising at least one light source emitting in the near-infrared range, said capture means comprising at least infrared two cameras covering said interaction space, said capture means being connected to a processing circuit, said device comprising a transparent panel delineating on the one hand the interaction space included in an external environment and on the other hand an internal space in which the light source and capture means are arranged, said capture means comprising a peripheral camera for capturing images representative of the external environment in the visible range, said device comprising at least one support element supporting said light source and/or the infrared cameras and at least one partially reflecting complementary element, the support element and the complementary element being separated by the transparent panel.

16. The device according to claim 15, comprising display means arranged in the internal space, said processing circuit being connected to the display means.

17. The device according to claim 16, wherein the display means comprise a diffusing and transparent film arranged in the internal space, in immediate proximity to the transparent panel, and a video projector arranged in the internal space and directed towards the transparent film.

18. The device according to claim 17, wherein the video projector is equipped with a band-stop filter in the infrared range.

19. The device according to claim 16, wherein the display means comprise an opaque screen.

20. The device according to claim 15, wherein the support element supporting the light source and/or the infrared cameras is a support bar pressing against the transparent panel.

21. The device according to claim 15, wherein the complementary element is a complementary bar comprising an inclined surface directed both towards the transparent panel and towards the interaction space.

22. The device according to claim 20, wherein the bars each comprise complementary magnets sandwiching the transparent panel.

23. A method for using the device according to claim 15, comprising a repetitive cycle successively comprising:
an acquisition step of infrared images by the infrared cameras and of images in the visible range by the peripheral camera,
processing of the acquired images,
merging of the infrared and visible images to generate an image representative of the external environment,
tracking of persons situated in the external environment.

24. The method according to claim 23, wherein, the device comprising display means, a modification step of the display according to the movements of the persons at the level of the interaction space is performed after the person tracking step.

25. The method according to claim 23, wherein, the external environment being divided into several sub-volumes, the processing circuit distinguishes the persons according to their positioning in the different sub-volumes and modifies the display accordingly.

26. The method according to claim 23, comprising, after the image processing step, an actimetry step performed on a corrected image of the peripheral camera.

27. The method according to claim 23, wherein the image processing step performs a foreground/background segmentation from the images from the peripheral camera.

28. The method according to claim 23, wherein the merging step comprises association of hands, fingers or an object detected by the infrared cameras, in the interaction space, with a corresponding user detected by the peripheral camera in the external environment.

29. The device according to claim 21, wherein the bars each comprise complementary magnets sandwiching the transparent panel.
